(19) United States
(12) Patent Application Publication
(10) Pub. No.: US 2018/0211166 A1
(43) Pub. Date: Jul. 26, 2018

(54) DISTRIBUTED DEEP LEARNING DEVICE AND DISTRIBUTED DEEP LEARNING SYSTEM

(71) Applicant: Preferred Networks, Inc., Tokyo (JP)

(72) Inventor: Takuya Akiba, Tokyo (JP)

(21) Appl. No.: 15/879,168

(22) Filed: Jan. 24, 2018

(30) Foreign Application Priority Data
Jan. 25, 2017 (JP) 2017-011699

(51) Int. Cl. G06N 3/08

(52) U.S. Cl. CPC G06N 3/08

(57) ABSTRACT

A distributed deep learning device that exchanges a quantized gradient with a plurality of learning devices and performs distributed deep learning, that includes: a communicator that exchanges the quantized gradient by communication with another learning device; a gradient calculator that calculates a gradient of a current parameter; a quantization remainder adder that adds, to the gradient, a value obtained by multiplying a remainder at the time of quantizing a previous gradient by a predetermined multiplying factor; a gradient quantizer that quantizes the gradient obtained by the quantization remainder adder; a gradient restorer that restores a quantized gradient received by the communicator to a gradient of the original accuracy; a quantization remainder storage that stores a remainder at the time of quantizing; a gradient aggregator that aggregates gradients collected by the communicator and calculates an aggregated gradient; and a parameter updater that updates the parameter with the aggregated gradient.

### CROSS-REFERENCE TO RELATED APPLICATIONS

This application claims priority to Japanese Patent Application No. 2017-011699 filed on Jan. 25, 2017 and entitled “Distributed Deep Learning Device and Distributed Deep Learning System,” which is assigned to the assignee of the present application.

### TECHNICAL FIELD

Embodiments relate to a distributed deep learning device and a distributed deep learning system that ensures both efficiency of calculation and reduction of communication traffic.

### BACKGROUND

Conventionally, there is a stochastic gradient descent method (hereinafter also referred to as SGD) as one of methods for optimizing a function adopted in machine learning and deep learning.

JP 2017-16414A aims to provide a neural network learning method having a deep hierarchy in which learning is completed in a short period of time and discloses that the stochastic gradient descent method is used in a learning process.

### SUMMARY OF EMBODIMENTS

There are cases where distributed deep learning is performed in which a plurality of computing devices is parallelized, and processing is performed by the plurality of computing devices. At that time, it is known that a trade-off between communication traffic and accuracy (=learning speed) can be controlled by quantizing and sharing obtained gradients.

Generally, since a remainder component is generated by quantizing at each learning node, a calculation is performed at each learning node by incorporating the remainder component in a next iteration. In the previous study, it is expected to improve learning efficiency by leaving information of remainder components.

However, it has not been known that convergence of SGD is delayed with the remainder component of gradient inherited to the next iteration by the quantization. That is, there is a problem that it is impossible to ensure both efficiency of calculation and reduction of communication traffic.

The present embodiments have been devised in view of the above problems, and it is an object of these embodiments to provide a distributed deep learning device and a distributed deep learning system which ensures both efficiency of calculation and reduction of communication traffic.

There is provided a distributed deep learning device that exchanges a quantized gradient with at least one or more learning devices and performs deep learning in a distributed manner, and the distributed deep learning device includes: a communicator that exchanges the quantized gradient by communication with another learning device; a gradient calculator that calculates a gradient of a current parameter; a quantization remainder adder that adds, to the gradient obtained by the gradient calculator, a value obtained by multiplying a remainder at the time of quantizing a previous gradient by a predetermined multiplying factor; a gradient quantizer that quantizes the gradient obtained by adding the remainder after the predetermined multiplication by the quantization remainder adder; a gradient restorer that restores a quantized gradient received by the communicator to a gradient of the original accuracy; a quantization remainder storage that stores a remainder at the time of quantizing the gradient in the gradient quantizer; a gradient aggregator that aggregates gradients collected by the communicator and calculates an aggregated gradient; and a parameter updater that updates the parameter on the basis of the gradient aggregated by the gradient aggregator.

In the distributed deep learning device, the predetermined multiplying factor is larger than 0 and smaller than 1.

A distributed deep learning system according to the present invention exchanges a quantized gradient among one or more master nodes and one or more slave nodes and performs deep learning in a distributed manner, in which each of the master nodes includes: a communicator that exchanges the quantized gradient by communication with one of the slave nodes; a gradient calculator that calculates a gradient of a current parameter; a quantization remainder adder that adds, to the gradient obtained by the gradient calculator, a value obtained by multiplying a remainder at the time of quantizing a previous gradient by a predetermined multiplying factor; a gradient quantizer that quantizes the gradient obtained by adding the remainder after the predetermined multiplication by the quantization remainder adder; a gradient restorer that restores a quantized gradient received by the communicator to a gradient of an original accuracy; a quantization remainder storage that stores a remainder at the time of quantizing the gradient in the gradient quantizer; a gradient aggregator that aggregates gradients collected by the communicator and calculates an aggregated gradient; an aggregate gradient remainder adder that adds, to the gradient aggregated in the gradient aggregator, a value obtained by multiplying an aggregate gradient remainder at the time of quantizing a previous aggregate gradient by a predetermined multiplying factor; an aggregate gradient quantizer that performs quantization on the aggregate gradient added with the remainder in the aggregate gradient remainder adder; an aggregate gradient remainder storage that stores a remainder at the time of quantizing in the aggregate gradient quantizer; and a parameter updater that updates the parameter on the basis of the gradient aggregated by the gradient aggregator, and each of the slave nodes includes: a communicator that transmits a quantized gradient to one of the master nodes and receives the aggregate gradient quantized in the aggregate gradient quantizer from the master node; a gradient calculator that calculates a gradient of a current parameter; a quantization remainder adder that adds, to the gradient obtained by the gradient calculator, a value obtained by multiplying a remainder at the time of quantizing a previous gradient by a predetermined multiplying factor; a gradient quantizer that quantizes the gradient obtained by adding the remainder after the predetermined multiplication by the quantization remainder adder; a gradient restorer that restores the quantized aggregate gradient received by the communicator to a gradient of an original accuracy; a quantization remainder storage that stores a remainder at the time of quantizing the gradient in the gradient quantizer; and a parameter updater that updates the parameter on the basis of the aggregate gradient restored by the gradient restorer.

In the distributed deep learning system according to embodiments, the predetermined multiplying factor is larger than 0 and smaller than 1.

According to the distributed deep learning device and the distributed deep learning system of the embodiments, by appropriately attenuating a remainder component of gradient for each iteration, an influence of Stale Gradient due to a remainder component of Quantized SGD remaining in the next iteration can be reduced. Thus, distributed deep learning can be stably performed, and a network band can be efficiently used. That is, it is possible to implement large scale distributed deep learning in a limited band with reduced communication traffic while efficiency of learning calculation in the distributed deep learning is maintained.

### BRIEF DESCRIPTION OF THE DRAWINGS

In the following drawings like reference numerals designate like structural elements. Although the figures depict various examples, the one or more embodiments and implementations described herein are not limited to the examples depicted in the figures, in which:

FIG. 1 is a block diagram illustrating a configuration of a distributed deep learning device according to some embodiments;

FIG. 2 is a flowchart illustrating a flow of parameter update processing in the distributed deep learning device according to some embodiments; and

FIG. 3 is a graph illustrating a relationship between the number of iterations and the test accuracy for each attenuation factor in learning by the distributed deep learning device according to some embodiments.

### DETAILED DESCRIPTION

### First Embodiment

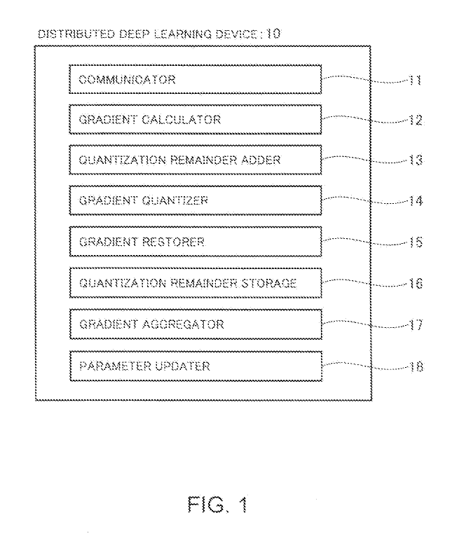

Hereinafter, a distributed deep learning device 10 according to the present invention will be described with reference to the drawings. FIG. 1 is a block diagram illustrating a configuration of the distributed deep learning device 10 according to an embodiment. Note that the distributed deep learning device 10 may be designed as a dedicated machine but can be implemented by a general computer. In this case, it is assumed that the distributed deep learning device 10 includes a central processing unit (CPU), a graphics processing unit (GPU), a memory, and a storage such as a hard disk drive (not illustrated) that are assumed to be usually included in a general computer. It goes without saying that various types of processing are executed by a program in order to cause such a general computer to function as the distributed deep learning device 10 of the present example.

As illustrated in FIG. 1, the distributed deep learning device 10 includes a communicator 11, a gradient calculator 12, a quantization remainder adder 13, a gradient quantizer 14, a gradient restorer 15, a quantization remainder storage 16, a gradient aggregator 17, and a parameter updater 18.

The communicator 11 has a function of exchanging quantized gradients by communication between distributed deep learning devices. For the exchange, all gather (data aggregation function) in Message Passing Interface (MPI) may be used, or another communication pattern may be used. In this communicator 11, gradients are exchanged among all distributed deep learning devices.

The gradient calculator 12 has a function of calculating a gradient of a parameter related to a loss function using given learning data using a model of the current parameter.

The quantization remainder adder 13 has a function of adding, to the gradient obtained by the gradient calculator 12, a value obtained by multiplying a remainder at the time of quantization stored in the quantization remainder storage 16 which will be described later in a previous iteration by a predetermined multiplying factor. Here, it is assumed that the predetermined multiplying factor is larger than 0.0 and smaller than 1.0. This is because a multiplying factor of 1.0 gives an ordinary quantized SGD, and a multiplying factor of 0.0 gives a case of not using the remainder (learning is not stable, and thus this is not useful). These are not intended cases of the present example. The multiplying factor here may be a fixed multiplying factor or a variable multiplying factor.

The gradient quantizer 14 has a function of quantizing the gradient obtained by adding the remainder after the predetermined multiplication by the quantization remainder adder 13 according to a predetermined method. Examples of the method of quantization include 1-bit SGD, sparse gradient, and random quantization. The gradient quantized by the gradient quantizer 14 is sent to the communicator 11, and the remainder at the time of quantization is sent to the quantization remainder storage 16 which will be described later.

The gradient restorer 15 has a function of restoring the quantized gradient exchanged by the communicator 11 to the gradient of the original accuracy. A specific method of restoration in the gradient restorer 15 corresponds to the quantization method in the gradient quantizer 14.

The quantization remainder storage 16 has a function of storing the remainder at the time of quantization transmitted from the gradient quantizer 14. The stored remainder is used in the quantization remainder adder 13 to be added to a next calculation result by the gradient calculator 12. Moreover, although it has been described that the multiplication by the predetermined multiplying factor is performed in the quantization remainder adder 13, the multiplication by the predetermined multiplying factor may be performed in the quantization remainder storage 16, and the remainder may be stored thereafter.

The gradient aggregator 17 has a function of aggregating gradients collected by the communicator and calculating a gradient aggregated among the distributed deep learning devices. The aggregation here is based on an assumption of an average or some calculation.

The parameter updater 18 has a function of updating a parameter on the basis of the gradient aggregated by the gradient aggregator 17.

The distributed deep learning device 10 having the above configuration communicates with other distributed deep learning devices to exchange quantized gradients. For connection with other distributed deep learning devices, for example, a device such as a packet switch device is used. Alternatively, a plurality of distributed deep learning devices may be virtually driven in the same terminal, and a quantized gradient may be exchanged among the virtual distributed deep learning devices. Alternatively, the same also applies to a case where a plurality of distributed deep learning devices is virtually driven on a cloud.

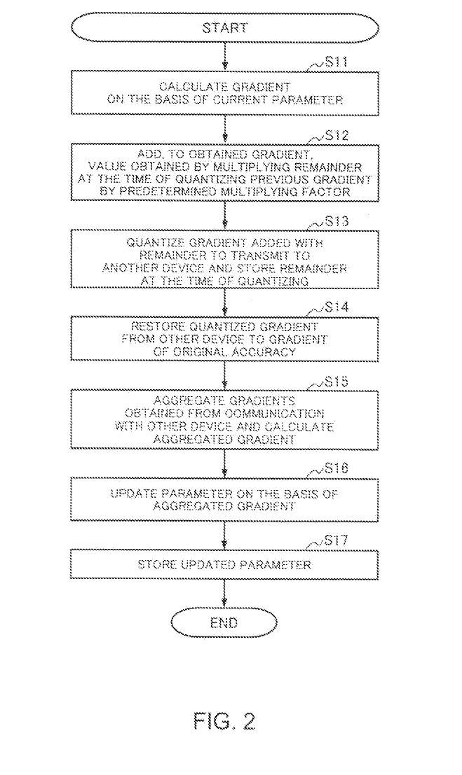

Next, a flow of processing in the distributed deep learning device 10 according to the present invention will be described. FIG. 2 is a flowchart illustrating a flow of parameter update processing in the distributed deep learning device 10 according to the present invention. In FIG. 2, the parameter update processing is started by calculating a gradient on the basis of the current parameter (step S11). Next, a value obtained by multiplying a remainder at a previous quantization stored by a previous iteration by a predetermined multiplying factor is added to the obtained gradient (step S12). The predetermined multiplying factor here is set to a value satisfying the condition of 0<predetermined multiplying factor<1. For example, in a case where the predetermined multiplying factor is 0.9, a value obtained from a remainder×0.9 is added to the obtained gradient. Note that the case where this predetermined multiplying factor of 0.9 is multiplied is expressed as attenuation factor=0.1. Next, the gradient obtained by adding the remainder after the predetermined multiplication is quantized and transmitted to another device, and a remainder at the time of the current quantization is stored (step S13). The other device referred to here is the other distributed deep learning devices for implementing distributed deep learning together in parallel. Similar parameter update processing is performed also in the other distributed deep learning device, and a quantized gradient is to be transmitted from the other device. The quantized gradient received from the other device is restored to the original accuracy (step S14). Next, gradients obtained by communication with the other device are aggregated, and an aggregated gradient is calculated (step S15). In the calculation of aggregation here, some arithmetic processing is performed, for example, arithmetic processing for obtaining an average of the aggregated gradients is performed. Then, the parameter is updated on the basis of the aggregated gradient (step S16). Thereafter, the updated parameter is stored (step S17), and the parameter update processing is terminated.

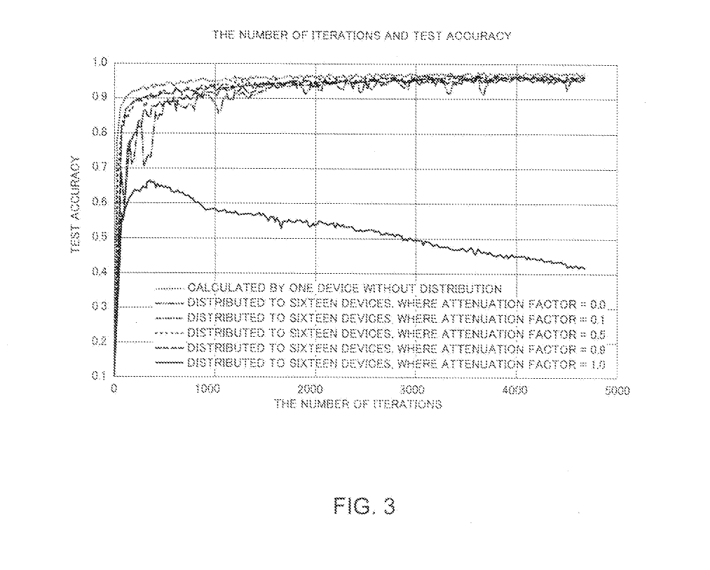

FIG. 3 is a graph illustrating a relationship between the number of iterations and the test accuracy for each attenuation factor in learning by the distributed deep learning device 10 according to the present invention. In a case where calculation is performed by one learning device without performing distributed learning, improvement in test accuracy is observed with less iterations compared to distributed cases, however, processing time required for one iteration becomes enormous compared with the distributed cases. Meanwhile in the case where processing is distributed to sixteen distributed deep learning devices, where attenuation factor=1.0 (predetermined multiplying factor=0.0) holds, that is, the case where a quantization remainder is not added, a result was obtained that learning was not stabilized and the test accuracy was not improved. On the other hand, in each of the cases where processing is distributed to sixteen distributed deep learning devices, where attenuation factor=0.0, 0.1, 0.5, and 0.9 holds, a result was obtained that increasing the number of iterations results in converging to substantially the same test accuracy. In the case of attenuation factor=0.0, a remainder is added as it is, and in the case of attenuation factor=0.1, a remainder is multiplied by a predetermined multiplying factor of 0.9 and thereby added. Although these cases tend to have great fluctuation in the test accuracy, they finally converged to substantially the same test accuracy. As for the case of attenuation factor=0.9 (predetermined multiplying factor=0.1), although a remainder is attenuated considerably, it is clear that convergence to substantially the same test accuracy occurred finally.

As described above, according to the distributed deep learning device 10 according to the present invention, by appropriately attenuating a remainder component of gradient for each iteration, an influence of Stale Gradient due to a remainder component of Quantized SGD remaining in the next iteration can be reduced, and at the same time, distributed deep learning can be stably performed, and a network band can be efficiently used. That is, it is possible to implement large scale distributed deep learning in a limited band with reduced communication traffic while efficiency of learning calculation in the distributed deep learning is maintained.

### Second Embodiment

In the first embodiment, the descriptions have been given assuming that each distributed deep learning devices 10 similarly execute the respective functions of the calculation of a gradient, the addition of a remainder after the predetermined multiplication, the quantization of the gradient, the storing of the remainder, the restoration of a gradient, the aggregation of gradients, and the updating of a parameter; however, the present invention is not limited thereto.

For example, a distributed deep learning system may include one master node and one or more slave nodes. Like the distributed deep learning device 10 according to the first embodiment, a distributed deep learning device 10a as one master node includes a communicator 11, a gradient calculator 12, a quantization remainder adder 13, a gradient quantizer 14, a gradient restorer 15, a quantization remainder storage 16, a gradient aggregator 17, and a parameter updater 18. Further included in addition to the above are an aggregate gradient remainder adder 19 that adds, to a gradient aggregated in the gradient aggregator 17, a value obtained by multiplying an aggregate gradient remainder at the time of a previous iteration by a predetermined multiplying factor, an aggregate gradient quantizer 20 that performs quantization on the aggregate gradient added with the remainder, and an aggregate gradient remainder storage 21 that stores a remainder at the time of quantizing in the aggregate gradient quantizer 20. A quantized aggregate gradient is transmitted to a distributed deep learning device 10b as a slave node via the communicator 11.

On the other hand, like the distributed deep learning device 10 in the first embodiment, each of distributed deep learning devices 10b as one or more slave nodes includes a communicator 11, a gradient calculator 12, a quantization remainder adder 13, a gradient quantizer 14, a gradient restorer 15, a quantization remainder storage 16, and a parameter updater 18 but does not include a gradient aggregator 17. The quantized aggregate gradient is restored in the gradient restorer 15 and directly given to the parameter updater 18. That is, updating of a parameter in the slave node is performed using the aggregate gradient received from the master node.

Note that, although the distributed deep learning system having one master node has been described; however, a distributed deep learning system may include two or more master nodes. In a case where there is a plurality of master nodes, parameters are shared by the plurality of master nodes, and each of the master node performs processing on parameters assigned thereto.

What is claimed is:

1. A distributed deep learning device that exchanges a quantized gradient with at least one or more learning devices and performs deep learning in a distributed manner, the distributed deep learning device comprising:
a communicator that exchanges the quantized gradient by communication with another learning device;
a gradient calculator that calculates a gradient of a current parameter;
a quantization remainder adder that adds, to the gradient obtained by the gradient calculator, a value obtained by multiplying a remainder at the time of quantizing a previous gradient by a predetermined multiplying factor larger than 0 and smaller than 1;
a gradient quantizer that quantizes the gradient obtained by adding the remainder after the predetermined multiplication by the quantization remainder adder;
a gradient restorer that restores a quantized gradient received by the communicator to a gradient of an original accuracy;
a quantization remainder storage that stores a remainder at the time of quantizing the gradient in the gradient quantizer;
a gradient aggregator that aggregates gradients collected by the communicator and calculates an aggregated gradient; and
a parameter updater that updates the parameter on the basis of the gradient aggregated by the gradient aggregator.

2. A distributed deep learning system that exchanges a quantized gradient among one or more master nodes and one or more slave nodes and performs deep learning in a distributed manner,
wherein each of the master nodes comprises:
a communicator that exchanges the quantized gradient by communication with one of the slave nodes;
a gradient calculator that calculates a gradient of a current parameter;
a quantization remainder adder that adds, to the gradient obtained by the gradient calculator, a value obtained by multiplying a remainder at the time of quantizing a previous gradient by a predetermined multiplying factor larger than 0 and smaller than 1;
a gradient quantizer that quantizes the gradient obtained by adding the remainder after the predetermined multiplication by the quantization remainder adder;
a gradient restorer that restores a quantized gradient received by the communicator to a gradient of an original accuracy;
a quantization remainder storage that stores a remainder at the time of quantizing the gradient in the gradient quantizer;
a gradient aggregator that aggregates gradients collected by the communicator and calculates an aggregated gradient;
an aggregate gradient remainder adder that adds, to the gradient aggregated in the gradient aggregator, a value obtained by multiplying an aggregate gradient remainder at the time of quantizing a previous aggregate gradient by a predetermined multiplying factor larger than 0 and smaller than 1;
an aggregate gradient quantizer that performs quantization on the aggregate gradient added with the remainder in the aggregate gradient remainder adder;
an aggregate gradient remainder storage that stores a remainder at the time of quantizing in the aggregate gradient quantizer; and
a parameter updater that updates the parameter on the basis of the gradient aggregated by the gradient aggregator, and
each of the slave nodes comprises:
a communicator that transmits a quantized gradient to one of the master nodes and receives the aggregate gradient quantized in the aggregate gradient quantizer from the master node;
a gradient calculator that calculates a gradient of a current parameter;
a quantization remainder adder that adds, to the gradient obtained by the gradient calculator, a value obtained by multiplying a remainder at the time of quantizing a previous gradient by a predetermined multiplying factor larger than 0 and smaller than 1;
a gradient quantizer that quantizes the gradient obtained by adding the remainder after the predetermined multiplication by the quantization remainder adder;
a gradient restorer that restores the quantized aggregate gradient received by the communicator to a gradient of an original accuracy;
a quantization remainder storage that stores a remainder at the time of quantizing the gradient in the gradient quantizer; and
a parameter updater that updates the parameter on the basis of the aggregate gradient restored by the gradient restorer.
